(19) United States
(12) Patent Application Publication
(10) Pub. No.: US 2005/0129042 A1
(43) Pub. Date: Jun. 16, 2005

(54) System and associated terminal, method and computer program product for controlling memory for storage of content

(75) Inventors: Ahti Muhonen, Hirvihaara (FI); Antti-Pentti Vainio, Espoo (FI); Ari Hannikainen, Turku (FI)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/738,836

(22) Filed: Dec. 16, 2003

(51) Int. Cl. H04L 12/28

(52) U.S. Cl. 370/412

(57) ABSTRACT

A system for controlling memory for storage of content includes a network entitiy, such as a terminal or a content source. The network entity includes a download manager capable of receiving a selection of at least one piece of content. The download manager is also capable of reserving at least a portion of a storage capacity of memory of a terminal for at least one of the selected piece(s) of content such that the terminal can thereafter receive and store the selected piece(s) of content into the reserved storage capacity. To facilitate reserving storage capacity, the selected piece(s) of content and/or content stored in memory of the terminal includes a set of one or more parameters, such as an expiration time, a deletion priority value and/or a download priority value.

### FIELD OF THE INVENTION

The present invention generally relates to systems and methods for controlling storage of content and, more particularly, to systems, methods and computer program products for reserving memory for storage of content in terminals.

### BACKGROUND OF THE INVENTION

The deployment of advanced high bit-rate mobile networks has opened up new opportunities for delivering a host of services in a way that was not possible with earlier second generation wireless networks. Recent mobile network systems including third generation (3G) systems such as those specified for use with the Global System for Mobile Communications (GSM) wireless standard, as well as General Packet Radio Service (GPRS) systems, enable the delivery of new digital services such as video calls and the playback of multimedia applications that are comprised of audio and video clips.

The increased bit rates of recent mobile network systems provide adequate performance for delivering high quality digital audio and acceptable quality moving image clips. However, at these transfer rates it may be difficult to handle exceedingly high data intensive tasks such as delivering high quality full-motion video and transferring very large data files to mobile terminals. In this regard, attempts at downloading large data files may lead to inconveniently long downloading times that can be undesirably costly for users. For this and other reasons, alternative broadband delivery techniques, such as Digital Video Broadcasting (DVB) techniques, have been investigated that could provide a practical solution for high data intensive tasks in terms of lower cost and convenience for the users involved.

The combined use of mobile telecommunications with a broadband delivery technique has been proposed in the past in order to achieve efficient delivery of digital services to users on the move. This would take advantage of existing infrastructures in the effort to provide personal communications (already prevalent) and the growing demand for Internet access, together with the expected rise of digital broadcasting, so that users can receive these services with a single device. The combination of mobile telecommunication and relatively very low cost digital broadband delivery techniques provides the possibility of interactive services such as uni-directional and bi-directional services such as audio and video streaming (e.g., TV, radio, etc.), file downloads, advanced gaming applications, etc.

However, there are some challenges with developing the mobile terminals needed for downloading or otherwise receiving content, data, information or the like, even when such mobile terminals combine use of telecommunication techniques with digital broadband data broadcast techniques (e.g., DVB-T). In this regard, mobile terminals are generally capable of storing only a limited amount of data. The ability of mobile terminals to receive and thereafter store a large amount of data at a high bit rate, however, can place a heavy storage capacity burden on the terminal. This is especially the case when multiple pieces of content are delivered to the mobile terminal, with the user desiring to receive one or more pieces of content at different times for viewing at a time subsequent to receiving the content. In mobile terminals that also operate as telecom devices, content storage is a particularly important issue since users expect sufficiently reasonable storage capacity for necessary communication purposes which they expect to be available.

### SUMMARY OF THE INVENTION

In light of the foregoing background, embodiments of the present invention provide an improved system and associated terminal, method and computer program product for controlling memory for storage of content, particularly for mobile terminals. In accordance with embodiments of the present invention, to control memory for storage of content, at least a portion of a storage capacity of the memory is capable of being reserved for selected piece(s) of content. In this manner, upon receiving the selected piece(s) of content, the respective pieces of content can be stored in the reserved portion of the storage capacity of the memory. To facilitate reserving storage capacity in accordance with embodiments of the present invention, content includes a set of one or more parameters. For example, each piece of content can include an expiration time, a deletion priority value and/or a download priority value. Based upon the expiration time and/or deletion priority value, then, content can be maintained in, or deleted from, memory of the terminal. And based upon the download priority value, content can be selectively downloaded from among selected piece(s) of content. In this regard, a terminal can be capable of receiving a large amount of data or content at a high bit rate with a reduced burden on the storage capacity of the terminal, even when multiple pieces of content are delivered to the mobile terminal, with the user desiring to view the different pieces of content at different times.

According to one aspect of the present invention, a system is provided for controlling memory for storage of content. The system includes a network entity, such as a terminal or a content source such as an origin server, short messaging service center (SMSC), multimedia messaging service center (MMSC), digital broadcaster, digital broadcast receiving terminal or the like. The network entity comprises a download manager capable of receiving a selection of at least one piece of content. The download manager is also capable of reserving at least a portion of a storage capacity of memory of a terminal for at least one of the selected piece(s) of content such that the terminal can thereafter receive and store the selected piece(s) of content into the reserved storage capacity of the memory. For example, the download manager can be capable of reserving at least a portion of the storage capacity of memory by storing padding data into memory of the terminal, where the padding data has a size at least as large as the size of the selected piece(s) of content.

More particularly, the download manager can be capable of determining if memory of the terminal has sufficient storage capacity for at least one of the selected piece(s) of content. And if memory does not have sufficient storage capacity, the download manager can instruct the terminal to delete at least one piece of content stored in memory of the terminal based upon the deletion priority value of each piece of content stored in memory. In this regard, the download manager can be capable of determining at least one piece of content having an exceeded expiration time. Thereafter, the download manager can identify a piece of content having a highest deletion priority value from the piece(s) of content having an exceeded expiration time, and instruct the terminal to delete the identified piece of content.

The download manager can be capable of repeatedly identifying a piece of content, and instructing the terminal to delete the identified piece of content, until either (a) memory of the terminal has sufficient storage capacity for the selected piece(s) of content, or (b) each piece of content having an exceeded expiration time has been identified and deleted. However, in various instances memory of the terminal does not have sufficient storage capacity for the selected piece(s) of content, and each of the piece(s) of content having an exceeded expiration time has been identified and deleted. In such instances, the download manager can be further capable of identifying at least one piece of content having a highest deletion priority value from at least one piece of content remaining in memory of the terminal, and instructing the terminal to delete the identified at least one piece of content.

The download manager can additionally or alternatively be capable of allocating the reserved storage capacity to at least one of the selected piece(s) of content based upon a download priority value associated with, and possibly further based upon the size of, each selected piece of content. The download manager can be capable of repeatedly allocating reserved storage capacity to a different selected piece of content having the highest deletion priority value from selected pieces of content not allocated reserved storage capacity. In this regard, the download manager can be capable of repeatedly allocating reserved storage capacity until (a) reserved storage capacity has been allocated to each of the selected at least one piece of content, or (b) memory of the terminal does not have sufficient storage capacity for at least one of the selected piece(s) of content not allocated reserved storage capacity.

The download manager can reserve at least a portion of the storage capacity in a number of different manners. For example, the download manager can be capable of reserving at least a portion of the storage capacity at least equal in size to a size of at least one of the selected piece(s) of content. In various instances, however, one or more of the selected piece(s) of content has a predicted size. In such instances, the download manager can be capable of reserving at least a portion of the storage capacity at least equal in size to the size or predicted size of at least one of the selected piece(s) of content. In various other instances, the piece(s) of content can be selected in one or more subscriptions for such content. In such instances, the download manager can be capable of reserving at least a portion of the storage capacity at least equal in size to a size of at least one of the selected piece(s) of content in the subscription(s).

According to other aspects of the present invention, a terminal, method and computer program product are provided for controlling memory for storage of content. Therefore, embodiments of the present invention provide a system and associated terminal, method and computer program product for controlling memory for storage of content. The system and associated terminal, method and computer program product of embodiments of the present invention are capable of controlling memory for storage of content, by reserving storage capacity of memory for storage of one or more selected piece(s) of content. To facilitate reserving storage capacity, the system and associated terminal, method and computer program product of embodiments of the present invention are capable of controlling the deletion of content stored in memory of the terminal based upon one or more parameters (e.g., expiration, and/or deletion priority value) associated with each piece of content. Further, the system, and associated terminal, method and computer program product of embodiments of the present invention are capable of controlling the download of content by allocating the reserved storage capacity to one or more of the selected piece(s) of content. As such, the terminal can be capable of receiving a large amount of data or content at a high bit rate with a reduced burden on the storage capacity of the terminal. Therefore, the system and associated terminal, method and computer program product of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a wireless communications system according to one embodiment of the present invention including a mobile network and a data network to which a terminal is bi-directionally coupled through wireless RF links;

FIG. 2 is a schematic block diagram of an entity capable of operating as a terminal, origin server, digital broadcast receiving terminal and/or a digital broadcaster, in accordance with embodiments of the present invention;

FIG. 3 is a functional block diagram of a digital broadcast receiving terminal, in accordance with one embodiment of the present invention;

FIG. 4 is a functional block diagram of the digital broadcaster, in accordance with one embodiment of the present invention;

FIG. 5 is a schematic block diagram of a mobile station that may operate as a terminal, according to embodiments of the present invention;

FIG. 6 is a functional block diagram of a terminal downloading or otherwise receiving content from a content source, in accordance with one embodiment of the present invention;

FIG. 7 is a flowchart of a method of controlling memory for storage of content in accordance with one embodiment of the present invention; and

FIGS. 8A and 8B are flowcharts of a method of controlling memory for storage of content in accordance with another embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

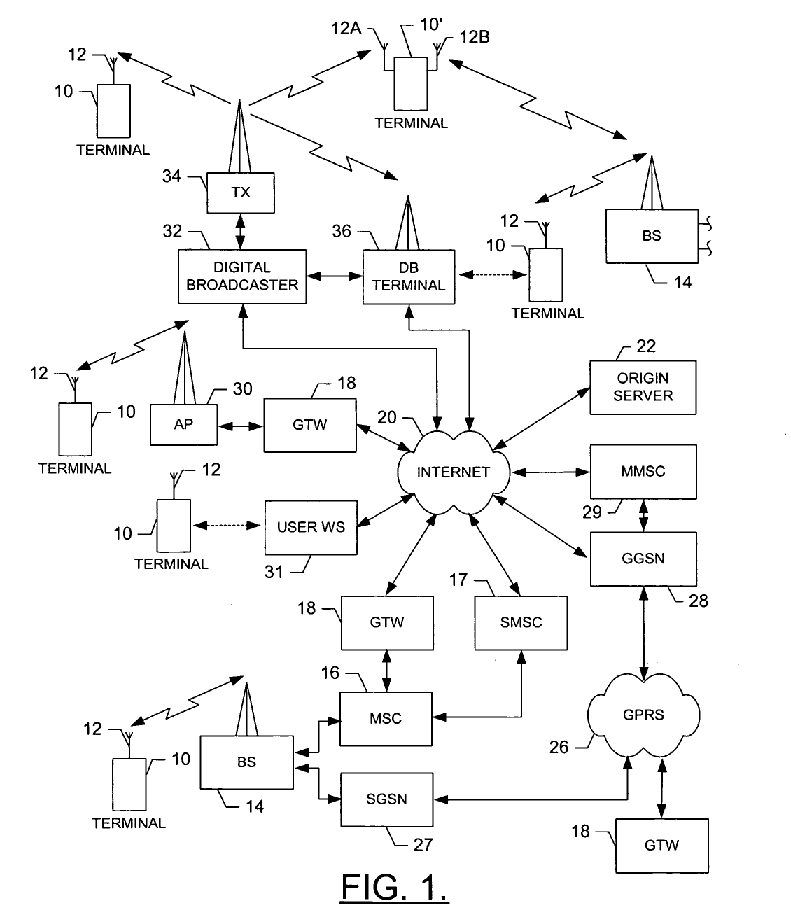

Referring to FIG. 1, an illustration of one type of terminal and system that would benefit from the present invention is provided. The system, method and computer program product of embodiments of the present invention will be primarily described in conjunction with mobile communications applications. It should be understood, however, that the system, method and computer program product of embodiments of the present invention can be utilized in conjunction with a variety of other applications, both in the mobile communications industries and outside of the mobile communications industries. For example, the system, method and computer program product of embodiments of the present invention can be utilized in conjunction with wireline and/or wireless network (e.g., Internet) applications.

As shown, a terminal 10 may include an antenna 12 for transmitting signals to and for receiving signals from a base site or base station (BS) 14. The base station is a part of one or more cellular or mobile networks that each include elements required to operate the network, such as a mobile switching center (MSC) 16. As well known to those skilled in the art, the mobile network may also be referred to as a Base Station/MSC/Interworking function (BMI). In operation, the MSC is capable of routing calls to and from the terminal when the terminal is making and receiving calls. The MSC can also provide a connection to landline trunks when the terminal is involved in a call. In addition, the MSC can be capable of controlling the forwarding of messages to and from the terminal, and can also controlling the forwarding of messages for the terminal to and from a messaging center, such as short messaging service (SMS) messages to and from a SMS center (SMSC) 17.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a GTW 18, and the GTW is coupled to a WAN, such as the Internet 20. In turn, devices such as processing elements (e.g., personal computers, server computers or the like) can be coupled to the terminal 10 via the Internet. For example, as explained below, the processing elements can include one or more processing elements associated with an origin server 22 or the like, one of which being illustrated in FIG. 1.

The BS 14 can also be coupled to a signaling GPRS (General Packet Radio Service) support node (SGSN) 24. As known to those skilled in the art, the SGSN is typically capable of performing functions similar to the MSC 16 for packet switched services. The SGSN, like the MSC, can be coupled to a data network, such as the Internet 20. The SGSN can be directly coupled to the data network. In a more typical embodiment, however, the SGSN is coupled to a packet-switched core network, such as a GPRS core network 26. The packet-switched core network is then coupled to another GTW, such as a GTW GPRS support node (GGSN) 28, and the GGSN is coupled to the Internet. In addition to the GGSN, the packet-switched core network can also be coupled to a GTW 18. Also, the GGSN can be coupled to a messaging center, such as a multimedia messaging service (MMS) center 29. In this regard, the GGSN and the SGSN, like the MSC, can be capable of controlling the forwarding of messages, such as MMS messages. The GGSN and SGSN can also be capable of controlling the forwarding of messages for the terminal to and from the messaging center.

In addition, by coupling the SGSN 24 to the GPRS core network 26 and the GGSN 28, devices such as origin servers 22 can be coupled to the terminal 10 via the Internet 20, SGSN and GGSN. In this regard, devices such as origin servers can communicate with the terminal across the SGSN, GPRS and GGSN. For example, origin servers can provide content to the terminal, such as in accordance with the Multimedia Broadcast Multicast Service (MBMS). For more information on the MBMS, see Third Generation Partnership Project (3GPP) technical specification 3GPP TS 22.146, entitled: Multimedia Broadcast Multicast Service (MBMS), the contents of which are hereby incorporated by reference in its entirety.

Although not every element of every possible mobile network is shown and described herein, it should be appreciated that the terminal 10 can be coupled to one or more of any of a number of different networks through the BS 14. In this regard, the network(s) can be capable of supporting communication in accordance with any one or more of a number of first-generation (1G), second-generation (2G), 2.5G and/or third-generation (3G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The terminal 10 can further be coupled to one or more wireless access points (APs) 30. The APs can comprise access points configured to communicate with the terminal in accordance techniques such as, for example, radio frequency (RF), Bluetooth (BT), infrared (IrDA) or any of a number of different wireless networking techniques, including WLAN techniques. Additionally, or alternatively, the terminal can be coupled to one or more user workstations (WS) 31. Each user workstation can comprise a computing system such as personal computers, laptop computers or the like. In this regard, the user workstations can be configured to communicate with the terminal in accordance with techniques such as, for example, RF, BT, IrDA or any of a number of different wireline or wireless communication techniques, including LAN and/or WLAN techniques. One or more of the user workstations can additionally, or alternatively, include a removable memory capable of storing content, which can thereafter be transferred to the terminal.

The APs 30 and the workstations 31 may be coupled to the Internet 20. Like with the MSC 16, the APs and workstations can be directly coupled to the Internet. In one advantageous embodiment, however, the APs are indirectly coupled to the Internet via a GTW 18. As will be appreciated, by directly or indirectly connecting the terminals and the origin server 22, as well as any of a number of other devices, to the Internet, the terminals can communicate with one another, the origin server, etc., to thereby carry out various functions of the terminal, such as to transmit data, content or the like to, and/or receive content, data or the like from, the origin server. As used herein, the terms “data,” “content,” “information” and similar terms may be used to interchangeably to refer to data capable of being transmitted, received and/or stored in accordance with embodiments of the present invention. Thus, use of any such terms should not be taken to limit the spirit and scope of the present invention.

Further, the terminal 10 can additionally, or alternatively, be coupled to any of a number of broadcast and/or multicast networks. For example, the terminal can be coupled to a digital video broadcasting network. As will be appreciated, for example, such a digital video broadcasting network can support communications in accordance with the Digital Video Broadcasting (DVB) standard and/or variants of the DVB standard, including DVB-T (terrestrial), DVB-MHP (multimedia home platform), DVB-H (handheld), DVB-C (cable), DVB-S (satellite) and/or DVB-IP. Further, for example, such a digital video broadcasting network can additionally or alternatively support communications in accordance with the Data Over Cable Service Interface Specification (DOCSIS), Japanese Terrestrial Integrated Service Digital Broadcasting (ISDB-T), Digital Audio Broadcasting (DAB), and MBMS, and those networks provided by the Advanced Television Systems Committee (ATSC).

In many such broadcasting networks, a containerization technique is utilized in which content for transmission is placed into MPEG-2 packets which act as data containers. Thus, the containers can be utilized to transport any suitably digitized data including, but not limited to High Definition TV, multiple channel Standard Definition TV (PAUNTSC or SECAM) and, of course, broadband multimedia data and interactive services. DVB-T, for example, is a wireless point-to-multipoint data delivery mechanism developed for digital TV broadcasting, and is based on the MPEG-2 transport stream for the transmission of video and synchronized audio. As will be appreciated by those skilled in the art, DVB-T also has the capability of efficiently transmitting large amounts of data over a broadcast channel to a high number of users at a lower cost, when compared to data transmission through mobile telecommunication networks using, e.g., 3G systems. Advantageously, DVB-T has further proven to be exceptionally robust in that it provides increased performance in geographic conditions that would normally affect other types of transmissions, such as the rapid changes of reception conditions, and hilly and mountainous terrain. On the other hand, other variations of this DVB-T are being developed to account for the capabilities of handheld devices (e.g., terminals 10), such as the power consumption of such devices.

More particularly, for example, the terminal can be coupled to a digital video broadcasting (e.g., DVB-T, DVB-H, ISDB-T, ATSC, etc.) network. As will be appreciated, by directly or indirectly connecting the terminals and the digital broadcaster, the terminals can receive content, such as content for one or more television, radio and/or data channels, from the digital broadcaster. In this regard, the digital broadcaster can include, or be coupled to, a transmitter (TX) 34, such as a DVB-T TX. Similarly, the terminal can include a receiver, such as a DVB-T receiver (not shown). The terminal can be capable of receiving content from any of a number of different entities in any one or more of a different number of manners. In one embodiment, for example, the terminal can comprise a terminal 10′ capable of transmitting and/or receiving data, content or the like in accordance with a DVB (e.g., DVB-T, DVB-H, etc.) technique as well as a mobile (e.g., 1G, 2G, 2.5G, 3G, etc.) communication technique. In such an embodiment, the terminal 10′ may include an antenna 12A for receiving content from the DVB-T TX, and another antenna 12B for transmitting signals to and for receiving signals from a BS 14. For more information on such a terminal, see U.S. patent application Ser. No. 09/894,532, entitled: Receiver, filed Jun. 29, 2001, the contents of which is incorporated herein by reference in its entirety.

In addition to, or in lieu of, directly coupling the terminal 10 to the digital broadcaster 32 via the TX 34, the terminal can be coupled to a digital broadcast (DB) receiving terminal 36 which, in turn, can be coupled to the digital broadcaster 32, such as directly and/or via the TX. In such instances, the digital broadcast receiving terminal can comprise a DVB-T receiver, such as a DVB-T receiver in the form of a set top box. The terminal can be locally coupled to the digital broadcast receiving terminal, such as via a personal area network. In one advantageous embodiment, however, the terminal can additionally or alternatively be indirectly coupled to the digital broadcast receiving terminal via the Internet 20.

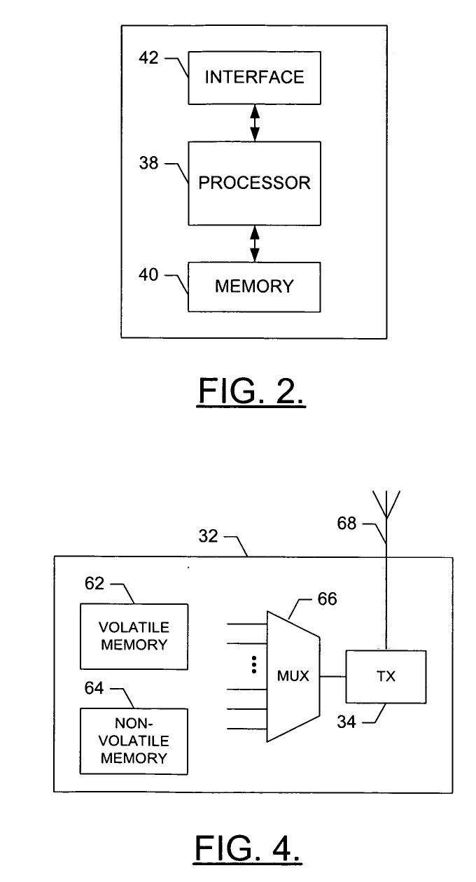

Referring now to FIG. 2, a block diagram of an entity capable of operating as a terminal 10, origin server 22, digital broadcast receiving terminal 36, and/or a digital broadcaster 32 is shown in accordance with one embodiment of the present invention. Although shown as separate entities, in some embodiments, one or more entities may support one or more of a terminal, origin server, digital broadcast receiving terminal, and/or a digital broadcaster, logically separated but co-located within the entit(ies). For example, a single entity may support a logically separate, but co-located, terminal and digital broadcast receiving terminal. Also, for example, a single entity may support a logically separate, but co-located digital broadcast receiving terminal and digital broadcaster.

As shown, the entity capable of operating as a terminal 10, origin server 22, digital broadcast receiving terminal 36, and/or a digital broadcaster 32 can generally include a processor 38 connected to a memory 40. The processor can also be connected to at least one interface 42 or other means for transmitting and/or receiving data, content or the like. The memory can comprise volatile and/or non-volatile memory, and typically stores content, data or the like. For example, the memory typically stores software applications, instructions or the like for the processor to perform steps associated with operation of the entity in accordance with embodiments of the present invention. Also, for example, the memory typically stores content transmitted from, or received by, the terminal, digital broadcast receiving terminal, and/or digital broadcaster. In addition, as described below, the memories can store a download manager capable of controlling storage of content received by the terminal.

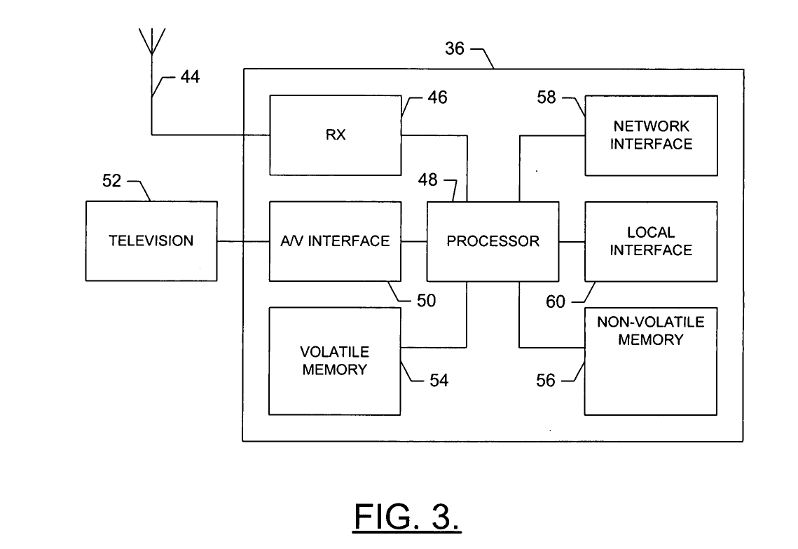

Reference is now made to FIG. 3, which illustrates a functional block diagram of a digital broadcast receiving terminal 36, in accordance with one embodiment of the present invention. As shown, the digital broadcast receiving terminal includes an antenna 44 for receiving signals from a digital broadcaster 32 and feeding the signals into a receiver (RX) 46. In turn, the receiver is capable of decrypting, demodulating and/or demultiplexing the signals, such as to extract content data. The receiver can feed the content data to a processor 48, which can thereafter decode the content data. The processor can then feed the decoded signal into an audio/video (A/V) interface 50, which can convert signals to a form suitable for display by a monitor, such as a television set 52.

The digital broadcast receiving terminal 36 can include volatile memory 54, such as volatile Random Access Memory (RAM) including a cache area for the temporary storage of data. The digital broadcast receiving terminal can also include non-volatile memory 56, which can be embedded and/or may be removable. The non-volatile memory can additionally or alternatively comprise an EEPROM, flash memory, hard disk or the like. The memories can store any of a number of pieces of information, content and data, used by the digital broadcast receiving terminal to implement the functions of the digital broadcast receiving terminal. For example, as indicated above, the memories can store content, such as that received from a digital broadcaster 32.

The digital broadcast receiving terminal 36 can also include one or more interface means for sharing and/or obtaining data from electronic devices, such as terminals 10 and/or digital broadcasters 32. More particularly, the digital broadcast receiving terminal can include a network interface means 58, for sharing and/or obtaining data from a network, such as the Internet 20. For example, the network interface means can include an Ethernet Personal Computer Memory Card International Association (PCMCIA) card configured to transmit and/or receive data to and from a network, such as the Internet.

The digital broadcast receiving terminal 36 can also include one or more local interface means 60 for locally sharing and/or obtaining data from electronic devices, such as a terminal. For example, the digital broadcast receiving terminal can include a radio frequency transceiver and/or an infrared (IR) transceiver so that data can be shared with and/or obtained in accordance with radio frequency and/or infrared transfer techniques. Additionally, or alternatively, for example, the digital broadcast receiving terminal can include a Bluetooth (BT) transceiver 52 operating using Bluetooth brand wireless technology developed by the Bluetooth Special Interest Group such that the digital broadcast receiving terminal can share and/or obtain data in accordance with Bluetooth transfer techniques. Further, the digital broadcast receiving terminal can additionally or alternatively be capable of sharing and/or obtaining data in accordance with any of a number of different wireline and/or wireless networking techniques, including LAN and/or WLAN techniques.

Reference is now made to FIG. 4, which illustrates a functional block diagram of the digital broadcaster 32 of one embodiment of the present invention. Like the digital broadcast receiving terminal 36, the digital broadcaster can include volatile memory 62, such as volatile Random Access Memory (RAM) including a cache area for the temporary storage of data. The digital broadcaster can also include non-volatile memory 64, which can be embedded and/or may be removable. The non-volatile memory can additionally or alternatively comprise an EEPROM, flash memory, hard disk or the like. The memories can store any of a number of pieces of information, content and data, used by the digital broadcaster to implement the functions of the digital broadcaster. For example, as indicated above, the memories can store content, such as content for a television channel and other content for a number of other television, radio and/or data channels.

The digital broadcaster 32 can also include a multiplexer 66, which can be capable of multiplexing content for a number of television, radio and/or data channels. The multiplexer can then feed the resulting signal into a TX 34, which can be separate from the digital broadcaster, as shown in FIG. 1, or incorporated within the digital broadcaster, as shown in FIG. 4. Irrespective of where the TX is located relative to the digital broadcaster, the TX can receive the signal from the multiplexer for encryption, modulation, amplification and/or transmission, such as via an antenna 68. In this regard, for example, the digital broadcaster can be capable of directly or indirectly transmitting content to a digital broadcast receiving terminal 36 and/or a terminal 10, such as in accordance with a digital broadcasting technique, such as DVB-T. For information on DVB-T, see European Telecommunications Standards Institute (ETSI) Standard EN 300 744, entitled: Digital Video Broadcasting (DVB): Framing structure, channel coding and modulation for digital terrestrial television, v.1.1.2 (1997) and related specifications, the contents of which are hereby incorporated by reference in their entirety.

In accordance with a number of digital broadcasting techniques, such as DVB-T, Internet Protocol (IP) Datacast (IPDC) can be utilized to provide audio, video and/or other content to terminals 10. In this regard, the digital broadcaster 32 can be capable of providing IP datacasting content to the terminal utilizing a digital broadcasting technique. As will be appreciated by those skilled in the art, digital broadcasting techniques such as DVB-T are essentially mobile in nature with a transmission site associated with each of a number of different cells. DVB-T, for example, uses MPEG-2 transport streams, and as such, IP data can be encapsulated into DVB transmission signals sent from the digital broadcaster, or more particularly the TX 34. Data streams including IP datagrams can be supplied from several sources, and can be encapsulated by an IP encapsulator (not shown). The IP encapsulator, in turn, can feed the encapsulated IP data streams into the data broadcasting (e.g., DVB-T) network.

The encapsulated IP data streams can then be transported to one or more transmission sites, where the transmission sites form cells of the data broadcasting network. For example, the encapsulated IP data streams can be transported to one or more transmission sites on an MPEG-2 transport stream for subsequent transmission over the air directly to the terminals, or to a receiver station serving one or more terminals. As will be appreciated, the MPEG-2 transport stream, from production by the IP encapsulator, to reception by the terminals or the receiver station, is typically uni-directional in nature. In this regard, IP packets containing the data can be embedded in multi-protocol encapsulation (MPE) sections that are transported within transport stream packets.

In addition to the IP packets, the MPE sections can also include forward error correction (FEC) information and time slicing information. By including information such as time slicing information, data can be conveyed discontinuously with the receiver (e.g., terminal 10), being capable of saving battery power by switching off when no data is being transmitted to the receiver. In other terms, in accordance with one time slicing technique, instead of using the current default method of continuous digital broadcasting (e.g., DVB-T) transmission, a time division multiplex-type of allocation technique can be employed (see, e.g., DVB-H standard). With such an approach, then, services can be provided in bursts, allowing a receiver to power down when the receiver is not receiving data, and allowing the receiver to power up to receive data packets, as necessary.

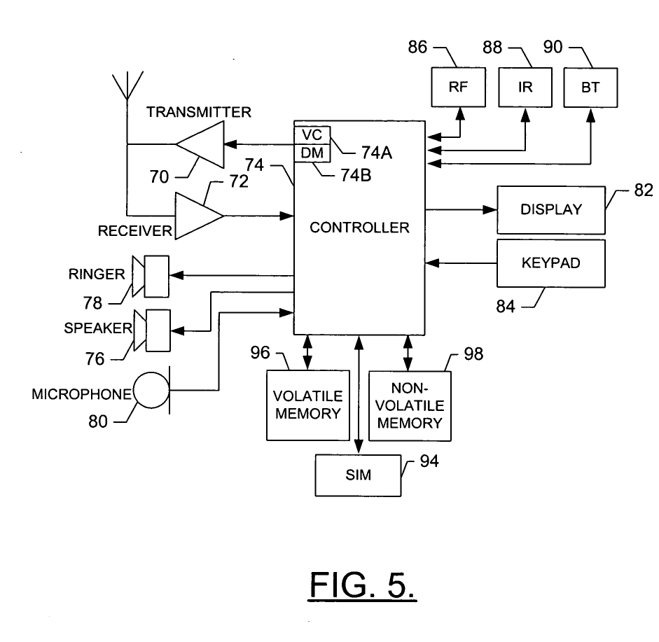

FIG. 5 illustrates a functional diagram of a mobile station that may operate as a terminal 10, according to embodiments of the invention. It should be understood, that the mobile station illustrated and hereinafter described is merely illustrative of one type of terminal that would benefit from the present invention and, therefore, should not be taken to limit the scope of the present invention. While several embodiments of the mobile station are illustrated and will be hereinafter described for purposes of example, other types of mobile stations, such as portable digital assistants (PDAs), pagers, laptop computers and other types of voice and text communications systems, can readily employ the present invention.

The mobile station includes a transmitter 70, a receiver 72, and a controller 74 that provides signals to and receives signals from the transmitter and receiver, respectively. These signals include signaling information in accordance with the air interface standard of the applicable mobile system, and also user speech and/or user generated data. In this regard, the mobile station can be capable of operating with one or more air interface standards, communication protocols, modulation types, and access types. More particularly, the mobile station can be capable of operating in accordance with any of a number of first-generation (1G), second-generation (2G), 2.5G and/or third-generation (3G) communication protocols or the like. For example, the mobile station may be capable of operating in accordance with 2G wireless communication protocols IS-136 (TDMA), GSM, and IS-95 (CDMA). Also, for example, the mobile station may be capable of operating in accordance with 2.5G wireless communication protocols GPRS, Enhanced Data GSM Environment (EDGE), or the like. The mobile station can additionally or alternatively be capable of operating in accordance with any of a number of different digital broadcasting techniques, such as the DVB technique (e.g., DVB-T, ETSI Standard EN 300 744). The mobile station can also be capable of operating in accordance with any of a number of different broadcast and/or multicast techniques, such as the MBMS technique (e.g., 3GPP TS 22.146). Further, the mobile station can be capable of operating in accordance with ISDB-T, DAB, ATSC techniques or the like. Some narrow-band AMPS (NAMPS), as well as TACS, mobile stations may also benefit from embodiments of the present invention, as should dual or higher mode mobile stations (e.g., digital/analog or TDMA/CDMA/analog phones).

It is understood that the controller 74 includes the circuitry required for implementing the audio and logic functions of the mobile station. For example, the controller may be comprised of a digital signal processor device, a microprocessor device, and various analog to digital converters, digital to analog converters, and other support circuits. The control and signal processing functions of the mobile station are allocated between these devices according to their respective capabilities. The controller thus also includes the functionality to convolutionally encode and interleave message and data prior to modulation and transmission. The controller can additionally include an internal voice coder (VC) 74A, and may include an internal data modem (DM) 74B. Further, the controller may include the functionally to operate one or more software applications, which may be stored in memory.

The mobile station also comprises a user interface including a conventional earphone or speaker 76, a ringer 78, a microphone 80, a display 82, and a user input interface, all of which are coupled to the controller 74. The user input interface, which allows the mobile station to receive data, can comprise any of a number of devices allowing the mobile station to receive data, such as a keypad 84, a touch display (not shown) or other input device. In embodiments including a keypad, the keypad includes the conventional numeric (0-9) and related keys (#, *), and other keys used for operating the mobile station.

The mobile station can also include one or more means for sharing and/or obtaining data from electronic devices, such as another terminal 10, an origin server 22, an AP 30, a digital broadcast receiving terminal 36, a digital broadcaster 32 or the like, in accordance with any of a number of different wireline and/or wireless techniques. For example, the mobile station can include a radio frequency (RF) transceiver 86 and/or an infrared (IR) transceiver 88 such that the mobile station can share and/or obtain data in accordance with radio frequency and/or infrared techniques. Also, for example, the mobile station can include a Bluetooth (BT) transceiver 90 such that the mobile station can share and/or obtain data in accordance with Bluetooth transfer techniques. Although not shown, the mobile station may additionally or alternatively be capable of transmitting and/or receiving data from electronic devices according to a number of different wireline and/or wireless networking techniques, including LAN and/or WLAN techniques. In this regard, as shown in FIG. 1 with respect to terminal 10′, the mobile station may include an additional antenna or the like to transmit and/or receive data from such electronic devices (e.g., digital broadcaster).

The mobile station can further include memory, such as a subscriber identity module (SIM) 94, a removable user identity module (R-UIM) or the like, which typically stores information elements related to a mobile subscriber. In addition to the SIM, the mobile station can include other memory. In this regard, like the digital broadcast receiving terminal 36 and the digital broadcaster 32, the mobile station can include volatile memory 96. Also, again like the digital broadcast receiving terminal and the digital broadcaster, the mobile station can include other non-volatile memory 98, which can be embedded and/or may be removable. For example, the other non-volatile memory can comprise embedded or removable multimedia memory cards (MMC's), Memory Sticks manufactured by Sony Corporation, EEPROM, flash memory, hard disk or the like.

The memories 94, 96, 98 can store any of a number of pieces of information, and data, used by the mobile station to implement the functions of the mobile station. For example, the memories can store an identifier, such as an international mobile equipment identification (IMEI) code, international mobile subscriber identification (IMSI) code, mobile station integrated services digital network (MSISDN) code or the like, capable of uniquely identifying the mobile station, such as to the MSC 16. The memories can also store content, such as that received from an origin server 22 and/or a digital broadcast receiving terminal. Also, for example, the memories can store one or more presentation applications such as a conventional text viewer, audio player, video player, multimedia viewer or the like. In addition, as described below, the memories can store a download manager capable of controlling storage of content received by the mobile station.

As explained in the background section, terminals 10 are generally capable of storing only a limited amount of data. And as such, the ability of content sources to deliver a large amount of data at a high bit rate to a terminal can place a heavy storage capacity burden on the terminal. This is especially the case when multiple pieces of content are delivered to the mobile terminal, with the user desiring to view the different pieces of content at different times. Embodiments of the present invention are therefore capable of controlling content storage in the terminal. More particularly, embodiments of the present invention are capable of reserving and/or allocating at least a portion of the memory of the terminal before downloading content from a content source.

In accordance with embodiments of the present invention, portions of the memory of the terminal 10 can be reserved and/or allocated in any of a number of different manners. In one embodiment, for example, portions of the memory can be reserved by selecting to download one or more pieces of content. Then, before the terminal downloads the selected content, a portion of the storage capacity of the terminal (i.e., memory not otherwise storing content) required to store the content can be reserved for storage of the selected content upon download by the terminal.

As will be appreciated, in various instances, the memory of the terminal 10 may not include sufficient storage capacity to reserve and/or allocate a portion of the storage capacity for selected content. In such instances, in one embodiment, at least a portion of the content stored in memory of the terminal can be deleted from memory or otherwise moved to another memory location of the terminal such that the respective portion of memory can be reserved and/or allocated for storage of selected content. In this regard, the portion of content deleted or otherwise moved can be selected in a number of different manners. For example, the respective portion of content can be selected based upon parameters, such as a deletion priority value and/or an expiration time, associated with each piece of stored content. In addition to, or in lieu of, deleting a portion of the content stored in memory of the terminal, a portion of the memory can be reserved and allocated to a portion of the selected content, such as based upon a size or one or more parameters associated with the selected content.

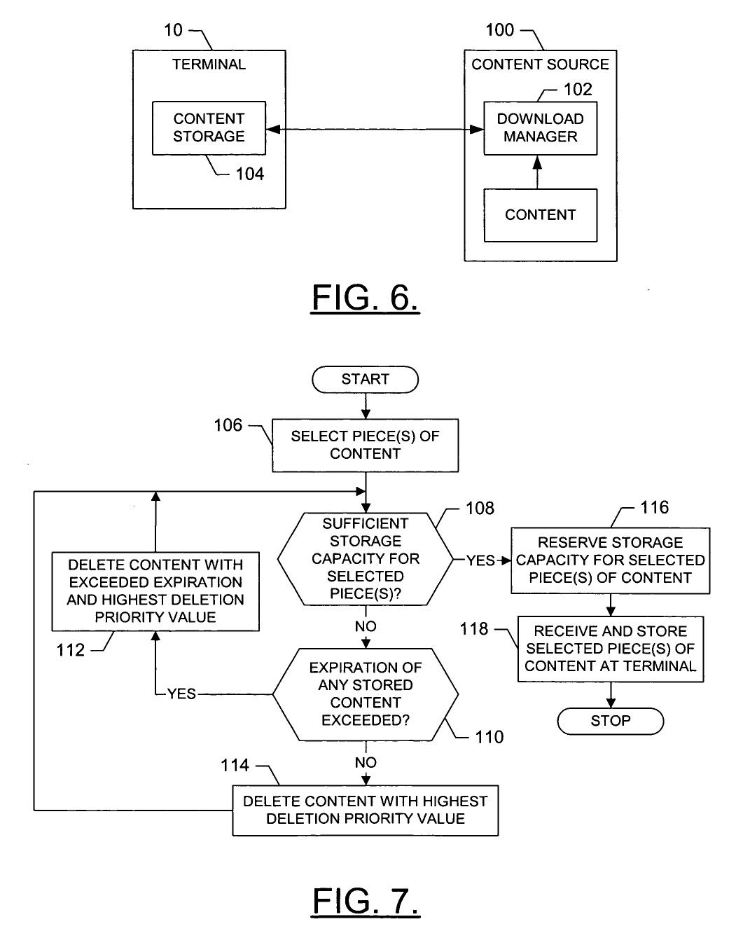

Reference is now drawn to FIGS. 6 and 7, which illustrate a functional block diagram and flowcharts, respectively, of a terminal 10 and method of downloading or otherwise receiving content, in accordance with one embodiment of the present invention. More particularly, FIG. 6 illustrates a functional block diagram of a terminal receiving content from a content source 100, such as an origin server 24, a SMSC 17, a MMSC 29, a digital broadcaster 34, a digital broadcast receiving terminal 36 or the like, in accordance with one advantageous embodiment of the present invention. As shown and described below, the content source operates a download manager 102 to control storage of content at the terminal. It should be understood, however, that although the content source is shown and described herein as operating the download manager, the download manager can be operated from any of a number of different network entities within the system including, for example, the terminal. Also, as described herein, the download manager typically comprises software capable of being stored within memory (e.g., memory 40), and operated by a processor (e.g., processor 38). It should be understood, however, that the download manager can alternatively comprise firmware or hardware, without departing from the spirit and scope of the present invention.

As shown in FIG. 6 and block 106 of FIG. 7, the content source 100 is capable of operating a download manager 102, which is capable of receiving, such as from the terminal 10, a selection of one or more pieces of content to transmit or otherwise send to the terminal. Although not shown, in one typical embodiment, a user of the terminal can subscribe, such as with the digital broadcaster, to content from one or more television, radio and/or data channels. In such instances, the selected piece(s) of content can comprise those piece(s) of content in accordance with the subscription. As will be appreciated, the selection of one or more piece(s) of content can comprise a selection of piece(s) of content for delivery to the terminal at one or more instances, such as during one or more download sessions of the terminal. Likewise, the selection can comprise a selection of piece(s) of content for delivery to the terminal periodically, such as in accordance with a subscription for the periodic delivery of content from one or more television, radio and/or data channels.

After receiving the selection of the piece(s) of content, the download manager can transmit or otherwise send the selected piece(s) of content from the content source to the terminal, such as in accordance with any of a number of different transfer techniques. The content can then be stored in a content storage 104 of the terminal, where the content storage of one advantageous embodiment comprises non-volatile memory (e.g., non-volatile memory 98). Before sending the content to the terminal for storing in the content storage, however, the download manager is capable of reserving storage capacity in the content storage for the selected piece(s) of content. In this regard, upon selecting the piece(s) of content, the download manager can receive, such as from the content source, the size of each of the selected piece(s) of content.

Before reserving storage capacity in the content storage 104 for the selected piece(s) of content, the download manager 102 can determine if the content storage (e.g., non-volatile memory 96) of the terminal has sufficient storage capacity to store the selected piece(s) of content, as shown in block 108. The download manager can determine if the content storage has sufficient storage capacity in any of a number of different manners, such as based upon the size of the selected piece(s) of content and the remaining storage capacity in the content storage. As described below, if the download manager determines that the content storage does not have sufficient storage capacity, the download manager can delete from the content storage, or otherwise move to another memory location of the terminal, one or more piece(s) of content until the content storage does have sufficient storage capacity.

To facilitate control of content storage in accordance with embodiments of the present invention, then, content stored by the content storage 104 can include a set of one or more parameters. For example, each piece of content can include an expiration time and/or a deletion priority value. The expiration time comprises an absolute and/or relative time that typically defines a minimum period of time the content storage 104 stores a respective piece of content. For example, the expiration time can comprise an absolute time, such as 4:00 PM, Oct. 2, 2003. Also, for example, the expiration time can comprise a relative time, such as five days. The deletion priority value typically comprises a measure of priority of a piece of content to deletion from the content storage (e.g., non-volatile memory 98) of the terminal 10. In this regard, the measure of priority comprises a measure of priority of the respective piece of content relative to other pieces of content. Based upon the expiration and/or deletion priority value, then, the download manager 102 can maintain the content in, or delete the content from, content storage such that the content storage has sufficient storage capacity to store the selected piece(s) of content.

To further facilitate control of content storage, the terminal 10 can be capable of sending, and the download manager 102 can be capable of receiving, at one or more instances, a memory status of the content storage 104 of the terminal. For example, the terminal can be triggered, such as by the download manager, to send a memory status to the download manager. Additionally, or alternatively, for example, the terminal can be configured to periodically send a memory status to the download manager. Further, for example, the terminal can be configured to send a memory status to the download manager when the memory capacity of the terminal changes, such as in response to the terminal deleting or otherwise removing one or more piece(s) of content from memory. Irrespective of when and how often the download manager receives a memory status, the memory status can include any of a number of different pieces of information regarding the memory of the terminal and the contents stored therein. For example, the memory status can include information regarding the remaining storage capacity of the memory of the terminal. In addition, for example, the memory status can include information regarding the pieces of content stored in memory, including one or more parameters of the set of parameters for each of the pieces of content, the time that the terminal received or otherwise downloaded each piece of content, and/or the time and/or manner that the terminal utilized each piece of content.

If, after receiving the selection of the piece(s) of content and a memory status, the download manager 102 determines that the content storage 104 of the terminal 10 does not have sufficient storage capacity to store the selected piece(s) of content, the download manager can determine if the expiration time of any one or more pieces of content stored in memory of the terminal has been exceeded, as shown in block 108. The download manager can determine if the expiration time of any piece(s) of content stored in memory of the terminal has been exceeded in any of a number of different manners. For example, when the expiration time comprises an absolute time, the download manager can determine if the current time is after the expiration time. Also, for example, when the expiration time comprises a relative time, the download manager can determine if the time between storing the respective piece of content and the current time is greater than the relative time. In this regard, the download manager can store the time at which the content storage stores or the download manager otherwise receives each piece of content, such as for subsequent comparison purposes.

If the download manager 102 determines that the expiration time of one or more piece(s) of content stored in the content storage 104 of the terminal 10 has been exceeded, the download manager can identify the piece of content having the highest deletion priority value from among those piece(s) of content with an exceeded expiration time. After identifying the piece of content having the highest deletion priority value, the download manager can instruct the terminal to delete or otherwise remove the respective piece of content from the content storage, as shown in block 112. Thereafter, the download manager can again determine if the content storage has sufficient storage capacity to store the selected piece(s) of content (see block 108).

If the download manager 102 again determines that the content storage 104 does not have sufficient storage capacity, the download manager can again identify, from the piece(s) of content remaining in the content storage, the piece of content having an exceeded expiration time and the highest deletion priority value. After identifying such a piece of content, the download manager can instruct the terminal 10 delete or otherwise remove the respective piece of content from memory (see block 112). Alternatively, the download manager can direct a user of the terminal to delete or otherwise remove the respective piece of content. As used herein, then, at each instance that the download manager instructs the terminal to delete or otherwise remove content from the content storage, the download manager can alternatively direct a user of the terminal to delete or otherwise remove the respective piece of content.

Irrespective of how the piece of content is deleted or removed from the content storage 104, the method can then repeatedly continue until either the content storage gains sufficient storage capacity to store the selected piece(s) of content, or the download manager 102 determines that the content storage does not include any piece of content having an exceeded expiration time. As such, by deleting the piece(s) of content in sequential order of the deletion priority value, not all of the pieces of content having exceeded expiration times need be immediately deleted from the content storage for the terminal to reserve storage capacity for the selected piece(s) of content. In this regard, the deletion priority value is typically set with the highest priorities assigned to the pieces of content that should be first deleted, and the lowest priorities assigned to the pieces of content that should be retained the longest.

If the download manager 102 determines that the content storage 104 of the terminal 10 does not have sufficient storage capacity for the selected piece(s) of content, but the content storage does not include any piece of content having an exceeded expiration time to delete from the content storage, the download manager can turn to the remaining piece(s) of content stored in the content storage. In this regard, the download manager can identify the piece of content having the highest deletion priority value from among those remaining piece(s) of content in memory of the terminal. After identifying the piece of content having the highest deletion priority value, the download manager can instruct the terminal to delete or otherwise remove the respective piece of content from memory, as shown in block 114. Thereafter, as before, the download manager can again determine if memory of the terminal has sufficient storage capacity to store the selected piece(s) of content (see block 108).

If the download manager 102 again determines that the content storage 104 of the terminal 10 does not have sufficient storage capacity, the download manager can again identify, from the piece(s) of content remaining in the content storage, the piece of content having the highest deletion priority value. After identifying such a piece of content, the download manager can instruct the terminal to delete or otherwise remove the respective piece of content from the content storage (see block 120). The method can then repeatedly continue until the content storage of the terminal gains sufficient storage capacity to store the selected piece(s) of content.

Once the download manager 102 determines that the content storage 104 of the terminal 10 does have sufficient storage capacity to store the selected piece(s) of content, either before or after deleting or otherwise removing one or more pieces of content from the content storage, the download manager can reserve at least a portion of the storage capacity of the content storage for subsequent storage of the selected piece(s) of content, as shown in block 116. The download manager can reserve a portion of the storage capacity in any of a number of different manners. For example, the download manager can reserve a portion of the storage capacity by directing the terminal to flag, write-protect or otherwise highlight a portion of the storage capacity such that only the selected piece(s) of content are capable of being stored in the reserved portion of the storage capacity. Alternatively, for example, the download manager can reserve a portion of the storage capacity by sending to the terminal, for storage in the content storage, one or more pieces of padding content, each piece at least the size of a corresponding selected piece of content. The padding content generally operates as a placeholder in the content storage for the selected piece(s) of content. As such, the padding content can comprise any of a number of different types of content such as, for example, a series of null bit values.

As will be appreciated, the download manager 102 can reserve the portion of the storage capacity 104 (including deleting piece(s) of content stored in the content storage to clear sufficient storage capacity) at any point after receiving the selection of the piece(s) of content. In one typical embodiment where the selected piece(s) of content comprise content in accordance with a content subscription, the download manager can reserve the portion of the storage capacity after the user of the terminal 10 subscribes to receive such content. Additionally or alternatively, for example, the download manager can reserve the portion of the storage capacity a selected time period, such as two hours, before downloading or otherwise receiving the selected piece(s) of content.

Irrespective of when the download manager 102 reserves the portion of the storage capacity, the download manager can thereafter send the selected piece(s) of content to the terminal 10, as shown in block 118. As indicated above, the download manager can send the selected piece(s) of content in accordance with any of a number of different transfer techniques. For example, the download manager can send the selected piece(s) of content in accordance with any of a number of different mobile (e.g., 1G, 2G, 2.5G, 3G, etc.) communication techniques such as GPRS, EDGE, MBMS or DVB (e.g., DVB-T, DVB-H, etc.), RF, BT, IrDA, and/or any of a number of different wireline and/or wireless networking techniques such as LAN and/or WLAN techniques, or via messaging services such as SMS, MMS, e-mail or the like.

As the terminal 10 receives the selected piece(s) of content, or after the terminal receives the selected piece(s) of content, the terminal can store the received piece(s) of content into the content storage 104. In this regard, the terminal can store the received, selected piece(s) of content into the portion of the storage capacity of the content storage reserved for the respective piece(s) of content. And in instances in which the download manager reserved the portion of the storage capacity by storing piece(s) of padding data into the reserved portion of the storage capacity of the content storage, the terminal can delete the padding data and thereafter store the received, selected piece(s) of content in the storage capacity of the content storage previously storing the padding data. Alternatively, the terminal can overwrite the padding data with the selected piece(s) of content.

As explained above, when the download manager 102 determines that the content storage 104 of the terminal 10 does not have sufficient storage capacity for the selected piece(s) of content, but the content storage of the terminal does not include any piece of content having an exceeded expiration time to delete from memory, the download manager can instruct the terminal to delete one or more pieces of content from among those remaining in memory of the terminal in sequential order of the deletion priority value. It should be understood, however, that in various instances it may be desirable to avoid deleting one or more pieces of content to thereby store the selected piece(s) of content. For example, in various instances, one or more pieces of content in memory of the terminal may have a higher deletion priority value than one or more of the selected piece(s) of content. As such, in accordance with one embodiment, before deleting one or more pieces of content from among those remaining in memory of the terminal in sequential order of the deletion priority value, the download manager can, but need not, compare the deletion priority value(s) of the selected piece(s) of content to the deletion priority value(s) of the piece(s) of content remaining in memory. The download manager can therefore only instruct the terminal to delete piece(s) of content from memory if those pieces of content have a deletion priority value higher than the deletion priority value(s) of the selected piece(s) of content.

As also explained above, the download manager 102 is capable of instructing the terminal 10 to delete content from the content storage 104 based upon parameters associated with respective piece(s) of content. It should be understood, however, that the parameters can alternatively prohibit the download manager from instructing the terminal to delete one or more respective pieces of content. In this regard, one or more pieces of content can have an unlimited server and/or expiration time, and/or can have a deletion priority value prohibiting the download manager from instructing the terminal from deleting the respective piece(s) of content. Such parameters, as well as one or more of the other parameters, can be associated with the respective piece(s) of content at the content source 100. Additionally, or alternatively, the parameters can be associated with the respective piece(s) of content, or associated parameters can be deleted, modified or the like at the content source and/or terminal, such as based upon user input.

As indicated above, in addition to, or lieu of, instructing the terminal 10 to delete or move one or more piece(s) of content such that the content storage 104 has storage capacity to store the selected piece(s) of content, the download manager 102 can reserve at least a portion of the storage capacity of the content storage and allocate the reserved portion of the storage capacity to one or more of the selected piece(s) of content. For example, the download manager can be capable of reserving at least a portion of the storage capacity of the content storage and allocating the reserved portion to one or more of the selected piece(s) of content when the content storage has sufficient storage capacity for at least one, but not all, of the selected piece(s) of content.

To facilitate the download manager 102 allocating the storage capacity to one or more of the selected piece(s) of content, each piece of content can include a parameter comprising a download priority value. The download priority value typically comprises a measure of priority of the download manager to download a piece of content from the content source 100. Like the deletion priority value, the measure of priority of the download priority value comprises a measure of priority of the respective piece of selected content relative to other pieces of selected content. In addition to the download priority value, the size of each of the selected piece of content can facilitate the download manager in allocating the storage capacity. Based upon the download priority value and/or size of each of the selected piece(s) of content, then, the download manager can allocate the storage capacity of the content storage to one or more of the selected piece(s) of content.

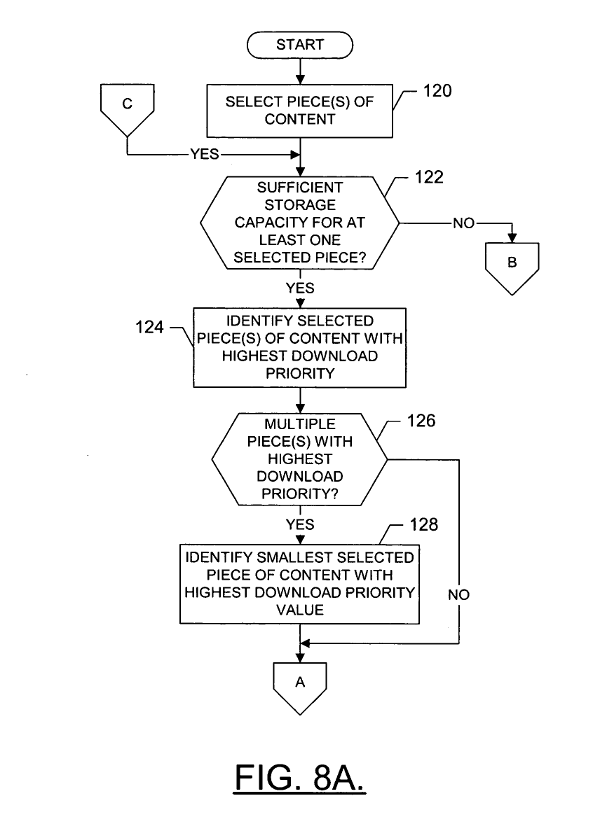

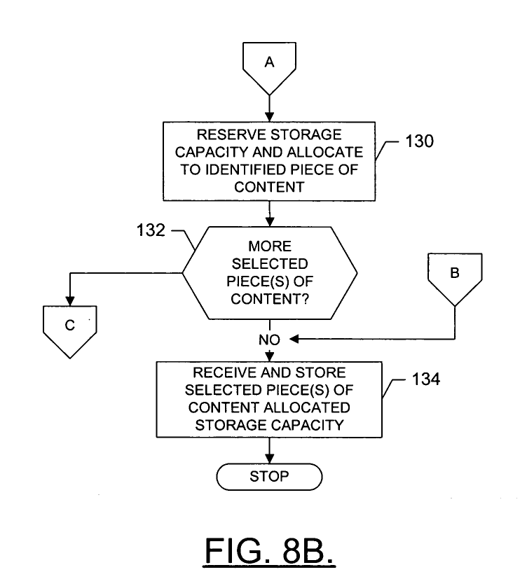

Reference is now made to FIGS. 8A and 8B, which illustrate a method of downloading or otherwise receiving content, in accordance with another embodiment of the present invention. As shown in block 120 of FIG. 8A, as before, the content source 100 is capable of operating a download manager 102, which is capable of receiving, such as from the terminal 10, a selection of one or more pieces of content to download or otherwise receive from the content source. Before sending the selected piece(s) content to the terminal for storing in the content storage, also as before, the download manager is capable of reserving storage capacity in the content storage for the selected piece(s) of content. In this regard, upon selecting the piece(s) of content, the content source can identify, to the download manager, the size of the selected piece(s) of content.

Before reserving storage capacity in the content storage 104 for the selected piece(s) of content, the download manager 102 can determine if the content storage 104 (e.g., non-volatile memory 96) of the terminal 10 has sufficient storage capacity to store at least one of the selected piece(s) of content, as shown in block 122. The download manager can determine if the content storage has sufficient storage capacity in any of a number of different manners, such as based upon the size of the selected piece(s) of content and the remaining storage capacity in the content storage. In this regard, if content storage has sufficient storage capacity to store at least one of the selected piece(s) of content, the download manager can identify one or more pieces of content having the highest download priority value from the selected piece(s) of content, as shown in block 124, where the identified piece(s) of content also have a size at most the size of the storage capacity.

The download manager 102 can identify the piece(s) of content having the highest download priority value in any of a number of different manners. In one typical embodiment, for example, after the download manager receives a selection of the piece(s) of content, the download manager can determine one or more parameters (including the download priority value) associated with each of the selected piece(s) of content. Then, from the selected piece(s) of content, the download manager can select the piece(s) of content that have the highest download priority value. Irrespective of how the download manager identifies the piece(s) of content having the highest download priority value, however, after identifying such piece(s) of content, the download manager can determine if multiple pieces of content have the highest download priority value, as shown in block 126. If multiple pieces of content have the highest download priority value, the download manager can identify the piece of content having the smallest size from the pieces of content having the highest download priority value, as shown in block 128. Thereafter, as shown in block 130, the download manager can reserve a portion of the storage capacity for the identified piece of content, whether the identified piece of content comprises that having the highest download priority value or that having the smallest size from multiple pieces of content having the highest download priority value.

After reserving a portion of the storage capacity of the content storage 104 for the identified piece of content, the download manager 102 can determine if any selected piece(s) of content remain that have not yet been allocated to reserved portions of the storage capacity of the content storage, as shown in block 132. If selected piece(s) of content do remain, the download manager can determine if content storage has sufficient storage capacity to store at least one of the remaining selected piece(s) of content (i.e., piece(s) of content other than those allocated to reserved storage capacity) (see block 122). Likewise, the download manager can again identify the selected piece of content having the highest download priority value or having the smallest size from multiple pieces of content having the highest download priority value (see blocks 124-128). Further, the download manager can again reserve storage capacity for the identified piece of content (see block 130). As will be appreciated, after each instance of reserving a portion of the storage capacity of the content storage, the storage capacity decreases by the size of the identified piece of content allocated to the reserved portion of the storage capacity. Thus, the download manager can typically continue the process until all of the selected piece(s) of content have been allocated to reserved portions of the storage capacity of the content storage, or until the content storage does not have sufficient storage capacity to store at least one of the remaining selected piece(s) of content.

Generally, the download manager 102 can send the selected piece(s) of content allocated to reserved portions of the storage capacity of the content storage 104 at any time after allocating the respective piece(s) of content to the reserved portion of the storage capacity. In one advantageous embodiment, however, the download manager sends the allocated, selected piece(s) of content after the download manager determines that the content storage does not have sufficient storage capacity to store at least one of the remaining selected piece(s) of content, or after the download manager has allocated all of the selected pieces of content to reserved portions of the content storage, as shown in block 134. In this regard, as before, the download manager can send the selected piece(s) of content to the terminal 10 in accordance with any of a number of different transfer techniques including those identified above. Then, as the terminal receives the selected piece(s) of content allocated to reserved portions of the storage capacity of the content storage, or after the terminal receives such piece(s) of content, the terminal can store the received piece(s) of content into the respective reserved portions of the storage capacity of the content storage, such as in the same manner as before.

As described above with respect to FIGS. 8A and 8B, the download manager 102 allocates reserved portions of the storage capacity of the content storage 104 based upon the selected piece(s) of content having the highest download priority value and, if multiple pieces of content have the highest download priority value, further based upon the piece of content having the smallest size. In this manner, the download manager places a priority on receiving and storing those piece(s) of content with higher download priority values. It should be understood, however, that the download manager can alternatively allocate reserved portions of the storage capacity of the content storage in a number of other manners based upon the download priority value and the size of the selected piece(s) of content. For example, the download manager can allocate reserved portions of the storage capacity of the content storage based upon the selected piece(s) of content having the smallest size and, if multiple pieces of content have the smallest size, further based upon the piece of content having the highest download priority value.

As described above with respect to the embodiment of FIG. 7, the download manager 102 can reserve a portion of the storage capacity of the content storage 104, and can instruct the terminal 10 to delete or move one or more piece(s) of content stored in the content storage, such as when the content storage has sufficient storage capacity for at least one, but not all, of the selected piece(s) of content. In the embodiment of FIGS. 8A and 8B, on the other hand, the download manager can reserve a portion of the storage capacity of the content storage, and can allocate the reserved portion of the storage capacity to one or more of the selected piece(s) of content, also such as when the content storage has sufficient storage capacity for at least one, but not all, of the selected piece(s) of content. It should be understood that the download manager can be capable of operating in accordance with both FIG. 7 and FIGS. 8A and 8B. For example, the download manager can be capable of instructing the terminal to delete or move one or more piece(s) of content stored in the content storage, and thereafter reserving a portion of the storage capacity of the content storage, and allocating the reserved portion of the storage capacity to one or more of the selected piece(s) of content.

Also, as described above, each piece of content can be associated with one or more parameters, such as a deletion priority value and a download priority value, that comprise measure(s) of the respective piece of content relative to other pieces of content. More particularly, for example, the deletion priority value is typically set with the highest priorities assigned to the pieces of content that should be first deleted, and the lowest priorities assigned to the pieces of content that should be retained the longest. Likewise, for example, the download priority value is typically set with the highest priorities assigned to the pieces of content that should be downloaded first, and the lowest priorities assigned to the pieces of content that should be downloaded after the piece(s) of content with higher deletion priority values. It should be understood, however, that the deletion priority value can be set with the highest priorities assigned to the pieces of content that should be retained the longest, and the lowest priorities assigned to the pieces of content that should be first deleted. Additionally, or alternatively, the download priority value can be set with the lowest priorities assigned to the pieces of content that should be downloaded first, and the highest priorities assigned to the pieces of content that should be downloaded after the piece(s) of content with lower deletion priority values.

As also described above, the download manager 102 is capable of reserving at least a portion of the storage capacity of the content storage 104 such that the terminal has sufficient storage capacity to store one or more of selected piece(s) of content. In this regard, the download manager can be capable of reserving storage capacity of the content storage equal in size to one or more of the selected piece(s) of content. Alternatively, for example, the download manager can be capable of reserving storage capacity having a size greater than that of selected piece(s) of content sent to the terminal during a first download session, such as by reserving storage capacity for storage of piece(s) of content periodically sent to the terminal in accordance with one or more subscriptions for such content. It should also be understood that in various instances the size of one or more of the selected piece(s) of content may not be known to the download manager at the time of reserving storage capacity. In such instances, the download manager can be capable of predicting a size of such piece(s) of content, such as based upon similar piece(s) of content. The download manager can then reserve storage capacity for such piece(s) of content, where the reserved storage capacity for such piece(s) of content has a size equal to or greater than the predicted size of such piece(s) of content.

In addition, it should be understood that when the selected piece(s) of content are sent to the terminal 10 at more than one instance, the size of one or more of the selected piece(s) of content can change, such as by increasing or decreasing in size. In such instances, the download manager 102 can be further capable of operating to reserve storage capacity to account for such an increase or decrease in size, typically before sending such piece(s) of content to the terminal. In this regard, the download manager can reserve storage capacity having a size greater than that of the selected piece(s) of content to account for such increases in the size of one or more piece(s) of content.

Further, as explained above, to facilitate control of content storage in accordance with embodiments of the present invention, content delivered to and stored by the terminal 10 includes a set of one or more parameters (e.g., expiration time, deletion priority value, download priority value, etc.). It should be understood, however, that the set of parameter(s) can be associated with the respective piece(s) of content in any of a number of different manners, at any of a number of different times, and at any of a number of different locations. For example, as described above, the piece(s) of content can be stored with associated set(s) of parameter(s), where the parameters can be associated with the content at a source of the content (e.g., origin server 22). Alternatively, for example, the terminal 10 can receive the piece(s) of content without associated parameters. After receiving the content, then, the terminal can associate one or more parameters with each piece of content. As will be appreciated, the terminal need not associate all of the associated parameters for each piece of content. For example, the content source can associate one or more parameters for the piece(s) of content, with the terminal (or a user of the terminal) subsequently setting the deletion priority value for one or more of the piece(s) of content.

In yet another alternative example, the terminal 10 can receive and store the piece(s) of content without associated parameters. Then, before or as the download manager 102 monitors the piece(s) of content stored in the content storage 104 (e.g., non-volatile memory 98) of the terminal, the download manager can associate one or more parameters with each piece of content. In this regard, particularly if the download manager associates the parameter(s) with the piece(s) of content, the download manager can be capable of associating the parameter(s) based upon information included in the memory status, such as an identifier of the piece(s) of content. Thus, the parameter(s) can be stored by the download manager, separate from the piece(s) of content.

The download manager 102 can therefore reserve memory (e.g., non-volatile memory 98) for storage of selected piece(s) of content. Then, if necessary, the download manager can control content stored in memory when the memory does not include sufficient storage capacity to reserve for the storage of selected piece(s) of content. Additionally, or alternatively, if necessary, the download manager can control the reception and storage of selected piece(s) of content, such as when the memory does not include sufficient storage capacity to reserve for the storage of selected piece(s) of content. Thus, the terminal can be capable of receiving one or more pieces of content at different times for viewing at a time subsequent to receiving the content, while placing a reduced burden on the storage capacity of the terminal.

According to one aspect of the present invention, all or a portion of the system of the present invention, such as all or portions of the terminal 10, digital broadcast receiving terminal 36, and/or a digital broadcaster 32, generally operates under control of a computer program product (e.g., download manager 102). The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIGS. 7, 8A and 8B are flowcharts of methods, systems and program products according to the invention. It will be understood that each block or step of the flowcharts, and combinations of blocks in the flowcharts, can be implemented by computer program instructions. These computer program instructions may be loaded onto a computer or other programmable apparatus to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowcharts block(s) or step(s).

Accordingly, blocks or steps of the flowcharts supports combinations of means for performing the specified functions, combinations of steps for performing the specified functions and program instruction means for performing the specified functions. It will also be understood that each block or step of the flowcharts, and combinations of blocks or steps in the flowcharts, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A system for controlling memory for storage of content, the system comprising:
a network entity comprising a download manager capable of receiving a selection of at least one piece of content, wherein the download manager is capable of reserving at least a portion of a storage capacity of memory of a terminal for at least one of the selected at least one piece of content such that the terminal can thereafter receive and store the selected at least one piece of content into the reserved storage capacity of memory.

2. A system according to claim 1, wherein the download manager of the network entity is capable of determining if memory of the terminal has sufficient storage capacity for at least one of the selected at least one piece of content, and if memory does not have sufficient storage capacity, instructing the terminal to delete at least one piece of content stored in memory of the terminal based upon a deletion priority value associated with each piece of content stored in memory.

3. A system according to claim 2, wherein the download manager of the network entity is capable of determining at least one piece of content having an exceeded expiration time, identifying a piece of content having a highest deletion priority value from the at least one piece of content having an exceeded expiration time, and instructing the terminal to delete the identified piece of content.

4. A system according to claim 3, wherein the download manager of the network entity is capable of repeatedly identifying a piece of content, and instructing the terminal to delete the identified piece of content, until one of (a) memory of the terminal has sufficient storage capacity for the selected at least one piece of content, and (b) each piece of content having an exceeded expiration time has been identified and deleted.

5. A system according to claim 4, wherein when memory of the terminal does not have sufficient storage capacity for the selected at least one piece of content and each piece of content having an exceeded expiration time has been identified and deleted, the download manager of the network entity is further capable of identifying at least one piece of content having a highest deletion priority value from at least one piece of content remaining in memory of the terminal, and instructing the terminal to delete the identified at least one piece of content.

6. A system according to claim 1, wherein the download manager of the network entity is capable of reserving at least a portion of the storage capacity of memory of the terminal by directing the terminal to store padding data into memory of the terminal, the padding data having a size at least as large as a size of the selected at least one piece of content.

7. A system according to claim 1, wherein the download manager of the network entity is further capable of allocating the reserved storage capacity to at least one of the selected at least one piece of content based upon a download priority value associated with each selected piece of content.

8. A system according to claim 7, wherein the download manager of the network entity is capable of allocating the reserved storage capacity further based upon a size of each selected piece of content.

9. A system according to claim 7, wherein the download manager of the network entity is capable of repeatedly allocating reserved storage capacity to a different selected piece of content having the highest deletion priority value from selected pieces of content not allocated reserved storage capacity.

10. A system according to claim 9, wherein the download manager of the network entity is capable of repeatedly allocating reserved storage capacity until one of (a) reserved storage capacity has been allocated to each of the selected at least one piece of content, and (b) memory of the terminal does not have sufficient storage capacity for at least one of the selected at least one piece of content not allocated reserved storage capacity.

11. A system according to claim 1, wherein the download manager is capable of reserving at least a portion of the storage capacity at least equal in size to a size of at least one of the selected at least one piece of content.

12. A system according to claim 11, wherein at least one of the selected at least one piece of content has a predicted size, and wherein the download manager is capable of reserving at least a portion of the storage capacity at least equal in size to one of a size and a predicted size of at least one of the selected at least one piece of content.

13. A system according to claim 1, wherein the download manager is capable of receiving a selection of at least one piece of content in at least one subscription for content, and wherein the download manager is capable of reserving at least a portion of the storage capacity at least equal in size to a size of at least one of the selected at least one piece of content in the at least one subscription.

14. A terminal comprising:
a memory capable of storing at least one piece of content; and
a controller capable of selecting at least one piece of content, wherein the controller is also capable of reserving at least a portion of a storage capacity of the memory for at least one of the selected at least one piece of content such that the terminal can thereafter receive and store the selected at least one piece of content into the reserved storage capacity of the memory.

15. A terminal according to claim 14, wherein the controller is capable of determining if the memory has sufficient storage capacity for at least one of the selected at least one piece of content, and if the memory does not have sufficient storage capacity, deleting at least one piece of content based upon a deletion priority value associated with each piece of content stored in memory.

16. A terminal according to claim 15, wherein the controller is capable of determining at least one piece of content having an exceeded expiration time, identifying a piece of content having a highest deletion priority value from the at least one piece of content having an exceeded expiration time, and deleting the identified piece of content.

17. A terminal according to claim 16, wherein the controller is capable of repeatedly identifying a piece of content, and deleting the identified piece of content, until one of (a) the memory has sufficient storage capacity for the selected at least one piece of content, and (b) each piece of content having an exceeded expiration time has been identified and deleted.

18. A terminal according to claim 17, wherein when the memory does not have sufficient storage capacity for the selected at least one piece of content and each piece of content having an exceeded expiration time has been identified and deleted, the controller is further capable of identifying at least one piece of content having a highest deletion priority value from at least one piece of content remaining in memory of the terminal, and deleting the identified at least one piece of content.

19. A terminal according to claim 14, wherein the controller is capable of reserving at least a portion of the storage capacity of the memory by storing padding data into the memory, the padding data having a size at least as large as a size of the selected at least one piece of content.

20. A terminal according to claim 14, wherein the controller is further capable of allocating the reserved storage capacity to at least one of the selected at least one piece of content based upon a download priority value associated with each selected piece of content.

21. A terminal according to claim 20, wherein the controller is capable of allocating the reserved storage capacity further based upon a size of each selected piece of content.

22. A terminal according to claim 20, wherein the controller is capable of repeatedly allocating reserved storage capacity to a different selected piece of content having the highest deletion priority value from selected pieces of content not allocated reserved storage capacity.

23. A terminal according to claim 22, wherein the controller is capable of repeatedly allocating reserved storage capacity until one of (a) reserved storage capacity has been allocated to each of the selected at least one piece of content, and (b) the memory does not have sufficient storage capacity for at least one of the selected at least one piece of content not allocated reserved storage capacity.

24. A terminal according to claim 14, wherein the controller is capable of reserving at least a portion of the storage capacity at least equal in size to a size of at least one of the selected at least one piece of content.

25. A terminal according to claim 24, wherein at least one of the selected at least one piece of content has a predicted size, and wherein the controller is capable of reserving at least a portion of the storage capacity at least equal in size to one of a size and a predicted size of at least one of the selected at least one piece of content.

26. A terminal according to claim 14, wherein the controller is capable of receiving a selection of at least one piece of content in at least one subscription for content, and wherein the controller is capable of reserving at least a portion of the storage capacity at least equal in size to a size of at least one of the selected at least one piece of content in the at least one subscription.

27. A method for controlling memory for storage of content, the method comprising:
selecting at least one piece of content; and
reserving at least a portion of a storage capacity of memory of a terminal for at least one of the selected at least one piece of content such that the terminal can thereafter receive and store the selected at least one piece of content into the reserved storage capacity of the memory.

28. A method according to claim 27 further comprising:
determining if memory of the terminal has sufficient storage capacity for at least one of the selected at least one piece of content; and if memory does not have sufficient storage capacity,
deleting at least one piece of content stored in memory of the terminal based upon a deletion priority value associated with each piece of content stored in memory.

29. A method according to claim 28, wherein deleting at least one piece of content comprises:
determining at least one piece of content having an exceeded expiration time; and
identifying, and thereafter deleting, a piece of content having a highest deletion priority value from the at least one piece of content having an exceeded expiration time.

30. A method according to claim 29, wherein identifying, and thereafter deleting, a piece of content comprise repeatedly identifying, and thereafter deleting, a piece of content until one of (a) memory of the terminal has sufficient storage capacity for the selected at least one piece of content, and (b) each piece of content having an exceeded expiration time has been identified and deleted.

31. A method according to claim 30, wherein when memory of the terminal does not have sufficient storage capacity for the selected at least one piece of content and each piece of content having an exceeded expiration time has been identified and deleted, the method further comprises:
identifying, and thereafter deleting, a piece of content having a highest deletion priority value from at least one piece of content remaining in memory of the terminal.

32. A method according to claim 27, wherein reserving at least a portion of a storage capacity comprises storing padding data into memory of the terminal, the padding data having a size at least as large as a size of the selected at least one piece of content.

33. A method according to claim 27 further comprising:
allocating the reserved storage capacity to at least one of the selected at least one piece of content based upon a download priority value associated with each selected piece of content.

34. A method according to claim 33, wherein allocating the reserved storage capacity comprises allocating the reserved storage capacity further based upon a size of each selected piece of content.

35. A method according to claim 33, wherein allocating the reserved storage capacity comprises repeatedly allocating reserved storage capacity to a different selected piece of content having the highest deletion priority value from selected pieces of content not allocated reserved storage capacity.

36. A method according to claim 35, wherein allocating the reserved storage capacity comprises repeatedly allocating reserved storage capacity until one of (a) reserved storage capacity has been allocated to each of the selected at least one piece of content, and (b) memory of the terminal does not have sufficient storage capacity for at least one of the selected at least one piece of content not allocated reserved storage capacity.

37. A method according to claim 27, wherein reserving at least a portion of the storage capacity comprises reserving at least a portion of the storage capacity at least equal in size to a size of at least one of the selected at least one piece of content.

38. A method according to claim 37, wherein at least one of the selected at least one piece of content has a predicted size, and wherein reserving at least a portion of the storage capacity comprises reserving at least a portion of the storage capacity at least equal in size to one of a size and a predicted size of at least one of the selected at least one piece of content.

39. A method according to claim 27, wherein selecting at least one piece of content comrpises selecting at least one piece of content in at least one subscription for content, and wherein reserving at least a portion of the storage capacity comprises reserving at least a portion of the storage capacity at least equal in size to a size of at least one of the selected at least one piece of content in the at least one subscription.

40. A computer program product for controlling memory for storage of content, the computer program product comprising a computer-readable storage medium having computer-readable program code portions stored therein, the computer-readable program code portions comprising:
a first executable portion for selecting at least one piece of content; and
a second executable portion for reserving at least a portion of a storage capacity of memory of a terminal for at least one of the selected at least one piece of content such that the terminal can thereafter receive and store the selected at least one piece of content into the reserved storage capacity of the memory.

41. A computer program product according to claim 40 further comprising:
a third executable portion for determining if memory of the terminal has sufficient storage capacity for at least one of the selected at least one piece of content; and if memory does not have sufficient storage capacity, deleting at least one piece of content stored in memory of the terminal based upon a deletion priority value associated with each piece of content stored in memory.

42. A computer program product according to claim 41, wherein the third executable portion is adapted to determine at least one piece of content having an exceeded expiration time, identify a piece of content having a highest deletion priority value from the at least one piece of content having an exceeded expiration time, and delete the identified piece of content.

43. A computer program product according to claim 42, wherein the third executable portion is adapted to repeatedly identify a piece of content, and thereafter delete the identified piece of content, until one of (a) memory of the terminal has sufficient storage capacity for the selected at least one piece of content, and (b) each piece of content having an exceeded expiration time has been identified and deleted.

44. A computer program product according to claim 43, wherein when memory of the terminal does not have sufficient storage capacity for the selected at least one piece of content and each piece of content having an exceeded expiration time has been identified and deleted, the computer program product further comprises:
a fourth executable portion for identifying a piece of content having a highest deletion priority value from at least one piece of content remaining in memory of the terminal, and deleting the identified piece of content.

45. A computer program product according to claim 40, wherein the second executable portion is adapted to store padding data into memory of the terminal, the padding data having a size at least as large as a size of the selected at least one piece of content.

46. A computer program product according to claim 40 further comprising:
a third executable portion for allocating the reserved storage capacity to at least one of the selected at least one piece of content based upon a download priority value associated with each selected piece of content.

47. A computer program product according to claim 46, wherein the third executable portion is adapted to allocate the reserved storage capacity further based upon a size of each selected piece of content.

48. A computer program product according to claim 46, wherein the third executable portion is adapted to repeatedly allocate reserved storage capacity to a different selected piece of content having the highest deletion priority value from selected pieces of content not allocated reserved storage capacity.

49. A computer program product according to claim 48, wherein the third executable portion is adapted to repeatedly allocate reserved storage capacity until one of (a) reserved storage capacity has been allocated to each of the selected at least one piece of content, and (b) memory of the terminal does not have sufficient storage capacity for at least one of the selected at least one piece of content not allocated reserved storage capacity.

50. A computer program product according to claim 40, wherein the second executable portion is adapted to reserve at least a portion of the storage capacity at least equal in size to a size of at least one of the selected at least one piece of content.

51. A computer program product according to claim 50, wherein at least one of the selected at least one piece of content has a predicted size, and wherein the second executable portion is adapted to reserve at least a portion of the storage capacity at least equal in size to one of a size and a predicted size of at least one of the selected at least one piece of content.

52. A computer program product according to claim 40, wherein the first executable portion is adapted to select at least one piece of content in at least one subscription for content, and wherein the second executable portion is adapted to reserve at least a portion of the storage capacity at least equal in size to a size of at least one of the selected at least one piece of content in the at least one subscription.
